(19) United States
(12) Patent Application Publication
(10) Pub. No.: US 2009/0119877 A1
(43) Pub. Date: May 14, 2009

(54) Embedded bumper for hinge

(75) Inventor: Rodney G. Garrett, Fort Madison, IA (US)

Correspondence Address: MCKEE, VOORHEES & SEASE, P.L.C., 801 GRAND AVENUE, SUITE 3200, DES MOINES, IA, 50309-2721, US

(73) Assignee: Custom Hardware Mfg., Inc., Keokuk, IA (US)

(21) Appl. No.: 11/200,698

(22) Filed: Aug. 10, 2005

Related U.S. Application Data
(60) Provisional application No. 60/600,709, filed on Aug. 10, 2004.

(51) Int. Cl. E05D 11/10

(52) U.S. Cl. 16/319

(57) ABSTRACT

A hinge assembly includes first and second portions that translate relative to one another. A bumper member is partially embedded in and partially extends out of one of the portions to prevent abutment of surfaces of the portions at that location.

### CROSS-REFERENCE TO RELATED APPLICATIONS

This application claims priority under 35 U.S.C. § 119 of a provisional application Ser. No. 60/600,709 filed Aug. 10, 2004, which application is hereby incorporated by reference in its entirety.

### I. BACKGROUND OF THE INVENTION

A. Field of the Invention

The present invention relates to an apparatus, method, and system of deterring scoring or abrasion between portions of a hinge device. One example is shown in U.S. Pat. No. 5,867,869.

B. Prior Art

U.S. Pat. No. 5,867,869, incorporated by reference herein, shows a pressure hinge device for glass doors or panels. In one embodiment, it can be made of solid relatively high cost metal, as these hinges are used many times for shower doors, and thus it is desirable to have a durable, highly aesthetic hinge.

As illustrated in U.S. Pat. No. 5,867,869, and described therein, such a hinge basically has two main parts, one of which rotates relative to the other around a main roller pin 50. As can be appreciated, and is somewhat illustrated in FIG. 11 of U.S. Pat. No. 5,867,869, if the portion that rotates (the two clamp bodies 28 and 26) are rotated past 90 degrees relative to tram body 78, a portion of either clamp body 28 or 26 can come into contact with the side of tram body 78. Even though persons opening and closing a glass panel door normally use care or are gentle in moving it from position to position, by accident, inadvertence, or otherwise, it can open to the point where contact between clamp body 26 or 28 and the side of tram body 78 occurs. Even if the contact is slight, at least over time, it can result in abrasion or scoring of the side of the tram body. And, obviously, if the door is opened with substantial force, this can occur in a single event. As can be appreciated, the weight of a full-size glass panel door is substantial, therefore the amount of force can be substantial to cause such abrasion or scoring.

Any surface damage to the side of the tram body is aesthetically displeasing and devalues the qualities of the hinge. Additionally, it is possible that it can be significant enough to encourage oxidation, especially if the scoring or abrasion removes the protective coating or the polishing of the surface of the metal.

Therefore, there is a real need in the art to address this issue.

### II. BRIEF SUMMARY OF THE INVENTION

The present invention relates to incorporating what will be called a bumper to one or the other of the hinge halves. The bumper will interface between the hinge halves at the normal point of possible contact between halves. The bumper will therefore deter direct metal-to-metal contact, or other contact, which can lead to abrasion or scoring of either parts of the hinge.

In one aspect of the invention, the bumper is elastomeric and mechanically attached so that a part is received in one of the hinge halves and a part extends slightly above a surface in the hinge half. The bumper is positioned so that it would be inbetween surfaces of the hinge halves that come towards one another and could possibly come into abutment so as to prevent abutment.

### III. BRIEF DESCRIPTION OF THE DRAWINGS

FIG. 1A is a perspective view of a hinge according to the present invention.

FIG. 1B is an enlarged isolated view taken at line A of FIG. 1A.

FIG. 1C is an end elevation of FIG. 1A showing in hidden lines interior components of the hinge.

FIG. 1D is a side elevation of FIG. 1A.

FIG. 1E is a top plan view of FIG. 1A, showing in hidden lines interior components.

FIG. 2A is a top plan view of a clamp body 26 like that of U.S. Pat. No. 5,867,869, but modified according to the present invention.

FIG. 2B is a side elevation of FIG. 2A.

FIG. 2C is an end elevation of FIG. 2A.

FIG. 2D is an enlargement taken at circle A of FIG. 2C.

FIG. 3A is a side elevation of a main roller 50 like that of U.S. Pat. No. 5,867,869 as modified according to the present invention.

FIG. 3B is a top plan view of FIG. 3A.

FIG. 3C is an end view of FIG. 3A.

FIG. 3D is an enlarged view of FIG. 3C.

FIG. 4A is a bottom plan view of tram body 78 like that of U.S. Pat. No. 5,867,869 but modified according to the present invention.

FIG. 4B is a sectional view taken along line A′-A′ of FIG. 4A.

FIG. 4C is an end view of FIG. 4A.

### IV. DETAILED DESCRIPTION OF AN EXEMPLARY EMBODIMENT

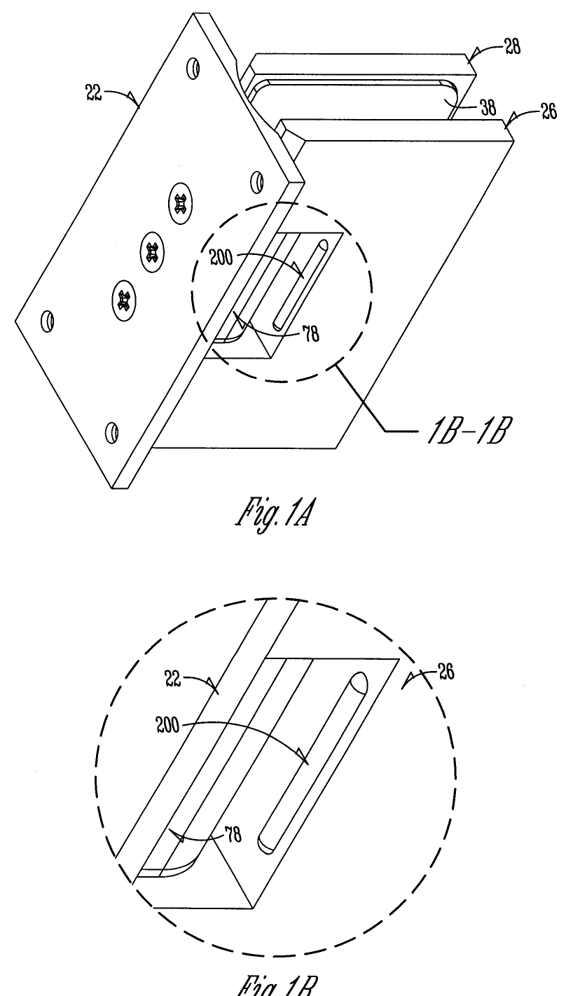

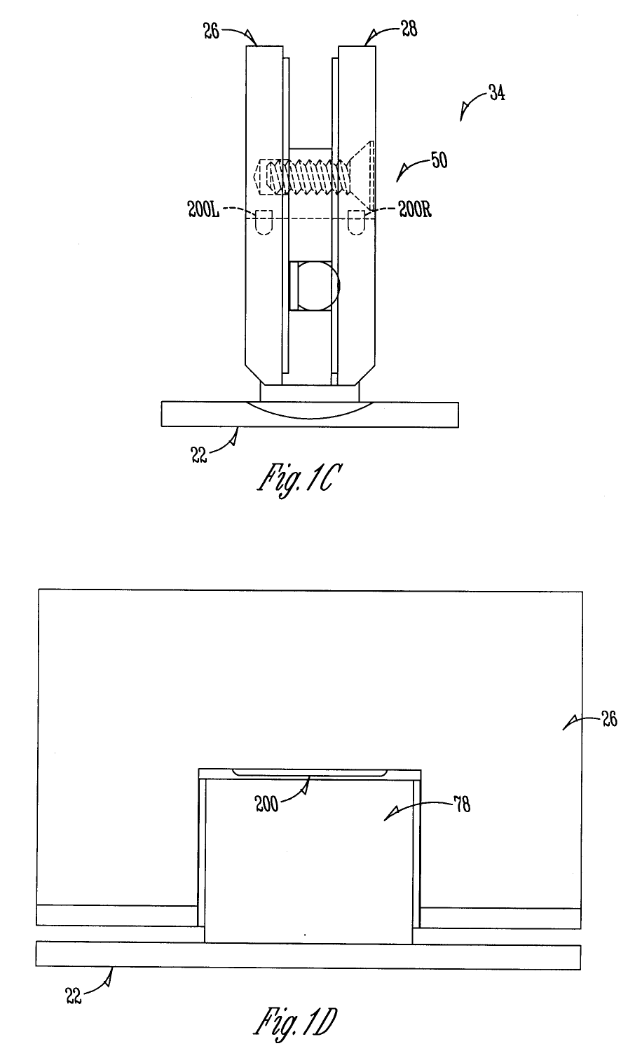

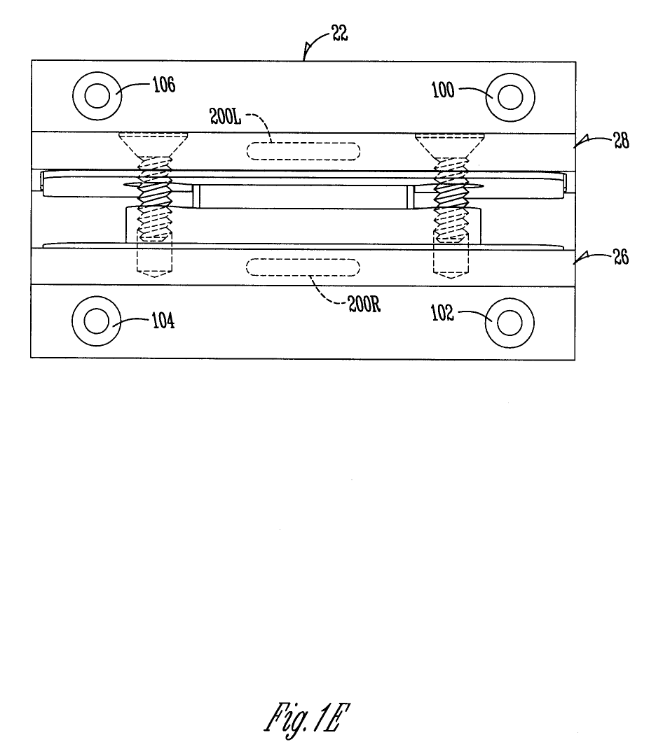

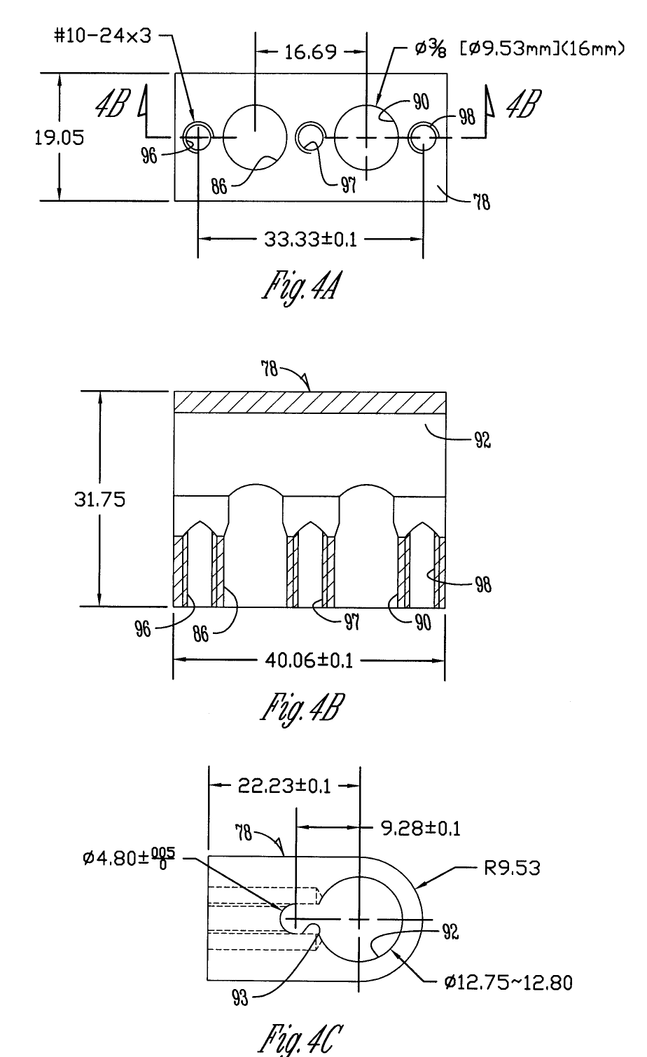

FIGS. 1-4 illustrate a hinge similar to that shown in U.S. Pat. No. 5,867,869. For purpose of the present invention, an exemplary embodiment of a bumper is illustrated in FIGS. 1-4. This is but one form the invention can take and is made for example purposes only and not by limitation to the invention. Variations obvious to those skilled in the art will be included in the invention.

As can be appreciated, particularly with reference to FIGS. 1A-E, the combination of clamp bodies 26 and 28, when the hinge is in final assembly, rotate together around tram body 78. As can be seen in FIG. 1D, clamp bodies 26 and 28 are essentially C-shaped. Tram body 78 fits within the C-shape.

As can be further appreciated, the combined clamp bodies 26 and 28 rotate around a horizontal axis in FIG. 1D that is basically defined by the roller pin 50 (please refer to U.S. Pat. No. 5,867,869 for such a description). If the combined clamp bodies 26 and 28 are pivoted around that axis sufficiently (e.g. over 90°), the horizontal portion of clamp body 26 or 28 in FIG. 1D, between the legs of the C-shape of that clamp body, will strike the side of tram body 78. As previously described, this can result in abrasion or scoring of the side of tram body 78.

In the exemplary embodiment shown in the figures, an a partially embedded bumper 200 made of an abrasion-resistant, resilient material (e.g. commercial grade molded urethane) is interference fit into a slot formed in that edge of both clamp bodies 26 and 28. When the rotating portion of the hinge (the combination of clamp bodies 26 or 28) is rotated to the point that edge comes near the side of clamp body 78, the exposed part of bumper 200 would prevent metal-to-metal contact and prevent abrasion or scoring.

In particular, FIG. 1A shows bumper 200 on the edge of clamping body 26. As can be seen in the enlarged detail of FIG. 1B, in this embodiment, the exposed part of bumper 200 is rounded, both around its longitudinal axis, and at opposite ends.

By referring to FIG. 1C, it can be seen that in this embodiment two embedded bumpers 200L and 200R (referring to a left side and a right side in FIG. 1C), are embedded, one in the edge of clamp body 26, one in the edge of clamp body 28. Thus, protection is offered whether the rotating part of the hinge goes in either direction relative to tram body 78.

FIG. 1D shows that the bumpers 200 would show from that viewing angle just a bit when the hinge is in its normal reference position.

As can be appreciated, bumper 200 could take many forms and embodiments. In one example, it is molded urethane shore A, 85 diameter. In this embodiment, bumper 200 is elongated along a long axis that covers a substantial distance of the edge at issue of the clamp body 26 or 28. Alternatively, it could be made of a plurality of embedded pieces or a single embedded piece with a plurality of portions extending out from the surface.

Still further, the material could be made of different colors or it could be clear or translucent.

FIG. 1E illustrates the relative position of both bumpers 200L and 200R when looking down in a top view of the hinge in its reference position.

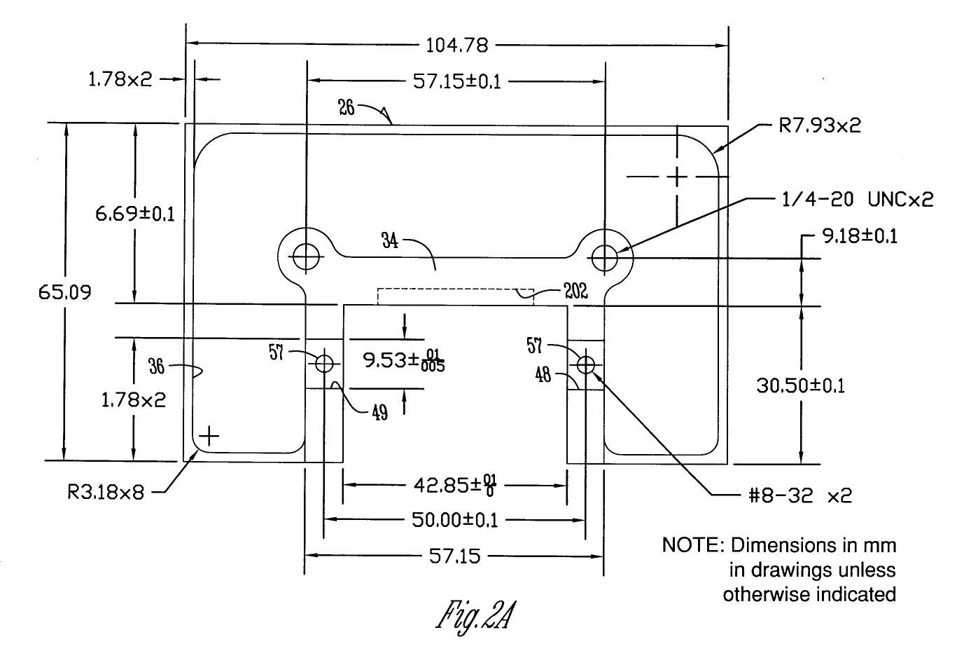

FIGS. 2A-D illustrate in detail the pocket or slot 202 in which bumper 200 is interference fit. In particular FIGS. 2B-D show details of bumper 200, and its dimensions, as well as its placement relative to the edge of a clamp body 26-28. As shown in these figures, bumper 200 is approximately 30 millimeters long and 3.18 millimeters wide. It has a portion that fits into the 3.00 millimeter depth of slot 202. Its dome or outward extending portion is approximately 1.055 millimeters tall. As mentioned it is interference fit, meaning that its width is as wide or slightly bigger than the width of slot 202.

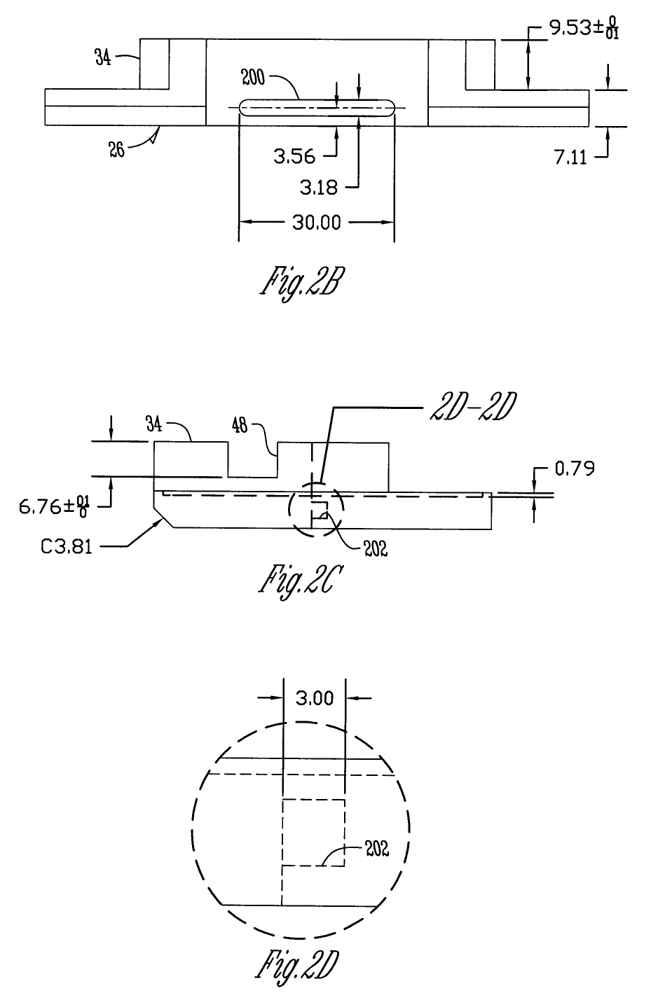

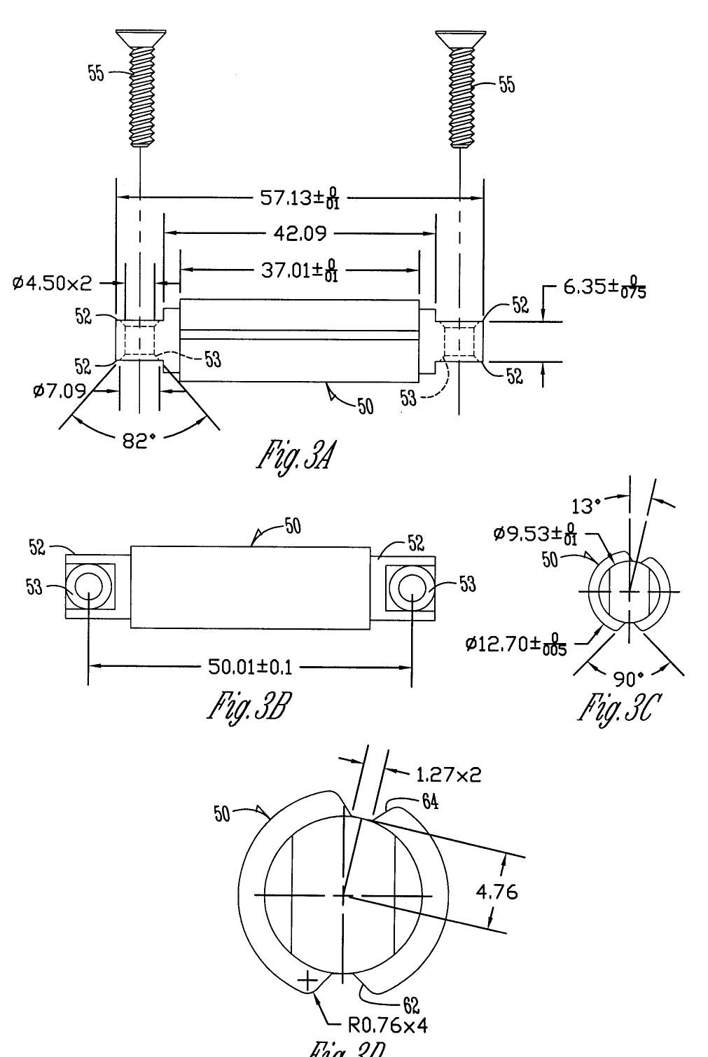

FIGS. 3A-D and 4A-C illustrate additional details of components for the exemplary embodiment of the hinge of FIG. 1A.

As can be appreciated, options, variations, and alternatives regarding the invention are possible. For example, if a door is only allowed to rotate in one direction, only one bumper on one side is perhaps needed. It also could be possible to put bumpers on both the tram body and the clamp body in alignment so that they abut one another when the hinge is rotated. The material of the bumper would be selected to accomplish its function and be durable over many years of service. It also should be selected to withstand water in high humidity locations.

As described herein, reference to “embedding” is one example of how the bumper could be mechanically attached to one of the hinge halves. It is intended to refer to insertion of a part of the bumper into a receiver in a hinge half. A mechanical attachment could be simply the restraining of that portion of the bumper by the receiving structure in the hinge half. One example is a slot in the hinge half into which the bumper would be matingly fit. The slot would prevent movement in most directions. Another example of mechanical attachment would be by interference fit. A slot or an opening could be sized such that the bumper, being slightly bigger in perimeter dimensions, is forced into the opening and is held in place by the interference fit. Other types of mechanical attachment are possible including screws, bolts, set screws, pins, molding, and other methods. Also, plural attachment methods can be used. For example, in addition to mechanical attachment, such things as adhesives could be used.

As can be appreciated, the combination is not costly to include but can deter damage or degradation of both the hinge and its aesthetic appearance over time.

As can be further appreciated, the precise configuration of the bumper or its materials can vary. Examples have been given in the foregoing specification. The example given includes some aesthetic features including the proportion of length versus width and height, the rounded surfaces, etc. Variations can be made that do not include those specific features. Additionally, multiple bumpers could be embedded or otherwise mechanically attached instead of a single bumper for each location.

Furthermore, the concept is applicable to a variety of different hinge types.

What is claimed is:

1. A hinge including first and second portions at least one of which is translatable relative to the other, and each portion having at least one surface that move closer to the other portion when the portions are translated relative to each other, the improvement comprising:
a bumper member partially embedded in one of the portions inbetween the said surface of each portion to prevent the surfaces from coming into abutment.

2. The hinge of claim 1 wherein the first portion includes a clamp adapted to grip a panel.

3. The hinge of claim 2 wherein the panel comprises a glass plate.

4. The hinge of claim 3 wherein the glass plate is adapted to be used as a door, window, or divider.

5. The hinge of claim 1 wherein the second portion includes a mount adapted for connection to a supporting structure.

6. The hinge of claim 5 wherein the supporting structure comprises a wall, frame, surface, or panel.

7. The hinge of claim 6 wherein the panel comprises a glass plate.

8. The hinge of claim 1 wherein the first and second portions are made of rigid material.

9. The hinge of claim 8 wherein the rigid material is metal.

10. The hinge of claim 8 wherein the rigid material is a composite material.

11. The hinge of claim 10 wherein the composite material comprises a metal outer coating.

12. The hinge of claim 1 wherein the bumper member is made of an elastomeric material.

13. The hinge of claim 1 wherein the elastomeric material is urethane.

14. The hinge of claim 1 wherein the bumper member is elongated.

15. The hinge of claim 1 wherein the bumper member has at least one rounded outer surface.

16. The hinge of claim 1 wherein the bumper member extends slightly from the surface in which it is embedded.

17. A hinge assembly including first and second portions that translate relative to one another comprising:
(a) at least one surface of the first portion adapted to move near or into abutment to a surface of the second portion;
(b) a member at least partially mechanically constrained in and partially extending out of one of the first and second portions.

18. The hinge assembly of claim 17 wherein the first portion comprises a clamp including an opening for a tram body connected to the second portion, wherein the clamp pivots around the tram body and has a surface that rotates towards abutment with a surface in the second portion when the clamp is pivoted relative the second portion.

19. The hinge assembly of claim 17 further comprising a second surface on the first portion that comes near or into abutment with the second member, and a second member at least partially mechanically constrained in and partially extending out of one of the first and second portions to prevent abutment of the second surface with the second member.

20. The hinge assembly of claim 17 wherein the member comprises a bumper.

21. The hinge assembly of claim 20 wherein the bumper has a first section adapted for insertion in a receiver in the first or second portion and a second section adapted to extend outside of the receiver.

22. The hinge assembly of claim 20 wherein the bumper is elastomeric.

23. The hinge assembly of claim 20 wherein the bumper is interference fit into one of the first and second members.

24. A method for protecting portions of a hinge that move towards each other during pivoting comprising:
partially embedding a bumper member in a hinge assembly between the surfaces such that it partially extends out of the hinge assembly to prevent abutment of the surfaces.

25. The method of claim 24 wherein the bumper extends slightly above the surface.

26. The method of claim 25 further comprising the second bumper member partially embedded in and partially extending above the surface of part of the hinge.
